(19) United States
(12) Patent Application Publication
(10) Pub. No.: US 2005/0139126 A1
(43) Pub. Date: Jun. 30, 2005

(54) Intumescent coating

(75) Inventors: Amir Khan, Wayne, NJ (US); Edward Nebesnak, Mine Hill, NJ (US); Michael DeSouto, Somerset, MA (US)

Correspondence Address: Attn: William J. Davis, Esq.;GAF MATERIALS CORPORATION, Legal Department, 1361 Alps Road, Building No. 8, Wayne, NJ, 07470, US

(73) Assignee: BUILDING MATERIALS INVESTMENT CORPORATION

(21) Appl. No.: 10/918,268

(22) Filed: Aug. 13, 2004

Related U.S. Application Data
(63) Continuation-in-part of application No. 10/749,672, filed on Dec. 31, 2003.

(51) Int. Cl. C09C 1/36

(52) U.S. Cl. 106/437; 106/472

(57) ABSTRACT

A coating composition useful for building materials products, especially roofing surfaces, is provided. The coating composition provides durable exterior protection to surfaces that it applied to, and it has intumescent and reflective properties. The coating composition includes a mixture of a polymeric binder, at least one intumescent agent, a polymeric carrier and a pigment. The pigment is present in the coating composition in amount that is capable of providing a coating that has an initial energy efficiency rating greater than or equal to 0.65 for a low-sloped roof, or an initial energy efficiency greater than or equal to 0.25 for a steep-sloped roof. The coating composition has a solids content from about 30-80% of which 0.5-35 wt. % is the intumescent agent.

### RELATED APPLICATIONS

This application is a continuation-in-part (CIP) application of U.S. Ser. No. 10/749,672, filed Dec. 31, 2003, the entire content of which is incorporated herein by reference.

### FIELD OF THE INVENTION

The present invention relates to a building materials coating composition, and more particularly to a coating composition for roofing products that provides durable exterior protection, and has intumescent and reflective properties. The coating composition of the present invention can be applied to any layer of a building materials product including a substrate thereof as the local job dictates.

### BACKGROUND OF THE INVENTION

Intumescent materials have been known for many years and have been employed as coatings that are capable of providing thermal protection up to approximately 650° C. Substrates such as wood, various metals including, for example, steel, iron, and aluminum, and various plastics such as polyvinyl chloride (PVC), thermoplastics and epoxies have been coated with an intumescent agent to make the substrates more fire-retardant.

In cases in which the intumescent coating is subjected to severe physical and environmental conditions, the application of the coating to one of the aforementioned substrates is impractical. In addition, with the increased use of wood and wood byproducts and the proliferation of new types of wood composites for use in building construction applications, and composites of plastics and other organic materials, current intumescent fire-retardant coating compositions do not provide adequate protection from fire and heat for a prolonged time period.

Currently, there is no single intumescent fire-retardant coating that is capable of: (I) reducing the available oxygen in confined areas, such as a room, to smother the fire and to retard the fire in the advent of a flashover; (II) providing a low rate of thermal transmission for coatings to protect various substrates, especially where low weight and low cost are critical; (III) providing an effective intumescent fire-retardant coating for roofing products which require zero flame spread for prolonged time exposure during a fire; (IV) providing sufficient mechanical properties and durability, to resist abrasion, impact and severe weather; (V) being non-toxic before it is exposed to heat, and the combustion products emitted upon exposure to heat, are below the gas level emissions required by today's transportation standards; and (VI) providing a coated roofing product that has an initial solar reflectance and a maintained solar reflectance that meets today's Energy Star® criteria.

Also, in many applications of an intumescent fire-retardant coating to a substrate, the intumescent coatings are impractical for reasons other than fire protection, as they lack abrasion resistance, impact resistance, water resistance, and resistance to other environmental factors. Because of these factors, present coatings do not provide protection from fire and heat for a sufficient time duration during a fire, and are not durable enough to last sufficiently long to make them cost effective.

One commonly employed intumescent agent for use in the building materials industry is hydrated alkali metal silicates. Under high temperatures that exist during a fire, the water of hydration is driven off causing the composition to expand by up to 20 to 40 times its original volume. Thus, when combined with fire-stop materials these silicates intumesce to provide a layer of insulation against fire and smoke.

Alkali metal silicates can also be incorporated into roofing materials such as asphalt shingles in order to convert these shingles into a fire retardant Class A or B form. Alkali metal silicate particles may be placed in an asphalt layer in between the top layer of asphalt and roofing granules and the substrate of organic felt or fiberglass mat. In the event of a fire on a roof, the intumescent silicate particles expand to form a thermal barrier which retards ignition of the roofing deck.

Despite their ongoing use in building material products, prior art coatings containing alkali metal silicates and other intumescent agents cannot provide a coating the satisfies the features mentioned above. Hence, there is a need for new and improved coating compositions that meet the above criteria. In particular, a coating composition for use in building products, particularly roofing products, is needed that is durable, intumescent (even after long exposure to moisture) and reflective (meeting today's Energy Star® criteria).

### SUMMARY OF THE INVENTION

The present invention provides a coating composition for use in building material products such as roofing products that provides durable exterior protection to the surface to which it is applied as well as superior fire resistance and reflectivity. The reflectivity provided by the inventive coating composition, which is dependent on the degree of sloping of the roofing surfaces, meets today's Energy Star® standards. The coating composition of the present invention can be applied to any layer of a building materials product, including a substrate thereof. For example, it can be applied to a surface of the substrate, to a surface of a first material layer applied on top of the substrate, to a second material layer that located atop the first layer and the substrate, and etc. The substrate or material layers to which the coating composition of the present invention is applied includes any type of material that is typically present in a building material product, including, for example, wood, cements, asphaltic surfaces, plastics, composites, and non-Energy Star® coatings such as primers and binders. In one preferred embodiment of the present invention, the coating composition of the present invention is a top coating composition that is applied to the outermost layer of a building materials product.

For low-sloped roofing products having surfaces with a slope that is typically 2:12 inches or less as measured by ASTM Standard E 1918-97, the coating of the present invention has an energy efficiency, as measured by its initial solar reflectance, that is typically greater than or equal to 0.65, and it maintains a solar reflectance for three years after installation under normal conditions that is typically greater than or equal to 0.50 (measured after the first year). Low-slope roofing products are typically installed on low-sloped surfaces such as single ply membranes, built-up roofing (BUR), modified bitumen, and standing-seam profile metal roofing.

For steep-sloped roofing products having surfaces with a slope that is typically greater than 2:12 inches, the coating of the present invention has an energy efficiency, as measured by its initial solar reflectance, that is typically greater than or equal to 0.25, and it maintains a solar reflectance for three years after installation under normal conditions that is typically greater than or equal to 0.15 (measured after the first year). Steep-sloped roofing products are typically installed on steep-sloped surfaces such as composite shingles, clay, concentrate, fiber cement tile, slate, shakes, architectural profiled metal and individual roofing components.

As indicated above, the energy efficiency of the coating of the present invention is determined by its solar reflectance. Solar reflectance by definition is the fraction of solar flux reflected by a surface expressed as a percent or within the range of 0.00 and 1.00.

The coating composition of the present invention comprises a mixture of a polymeric binder, at least one intumescent agent, preferably heat expandable graphite particles, a polymeric carrier, and an effective amount of a pigment that is capable of providing a coating that has an initial energy efficiency rating greater than or equal to 0.65 for a low-sloped roof, or an initial energy efficiency greater than or equal to 0.25 for a steep-sloped roof, wherein said mixture has a solids content from about 30-80% of which 0.5-35 wt. % is said intumescent agent.

The present invention is also related to the film, i.e., coating, that is formed from the coating composition of the present invention as well as roofing products that are coated with the same.

### DETAILED DESCRIPTION OF THE INVENTION

As indicated above, the present invention provides a coating composition for roofing products that provides durable exterior protection, superior fire resistance, and is highly reflective to solar energy. These properties are for the layer that the inventive coating composition of the present invention is applied to. The highly reflective nature of the coating composition of the present invention can provide a solar reflective coating that minimizes energy expended in air conditioning and levels temperature within a building structure.

The coating composition of the present invention includes a mixture of a polymeric binder, at least one intumescent agent, a polymeric carrier and an effective amount of a pigment that is capable of providing a coating that has an initial energy efficiency rating greater than or equal to 0.65 for a low-sloped roof, or an initial energy efficiency greater than or equal to 0.25 for a steep-sloped roof.

The mixture of the present invention has a solids content from about 30-80% of which 0.5-35 wt. % is the intumescent agent. More typically, the mixture has a solids content from about 50 to about 75%, with a solids content from about 60 to about 70% being even more typical. In some embodiments, the intumescent agent is present in said coating composition in an amount from about 1 to about 10%.

The polymeric binder employed in the present invention is any thermoplastic polymer or thermoplastic rubber that is capable of forming a film upon curing. The polymeric binders employed in the present invention are typically in latex form. Suitable polymeric binders employed in the top coating composition of the present invention include, but are not limited to: acrylic or methacrylic polymers or copolymers, epoxy resins, polyvinyl acetate resins and thermoplastic rubbers such as styrene-butadiene rubbers, styrene-butadiene-styrene rubbers, styrene-ethylene-butadiene-styrene (SEBS) rubbers, styrene isoprene styrene (SIS) rubbers, and styrene butadiene rubbers (SBR). Urethane is another type of polymeric binder that can be employed in the present invention.

In some embodiments, thermoplastic polymers, especially acrylic polymers or copolymers are employed as the polymeric binder of the coating composition of the present invention. In other embodiments, a thermoplastic rubber such as SEBS is employed as the polymeric binder.

The polymeric binder component of the inventive coating composition is typically present in the resultant mixture in an amount from about 5 to about 60 wt. %; the actual amount is dependent on the type of binder (thermoplastic polymers are present in a higher amount than thermoplastic rubbers). For example, and when the polymeric binder is an acrylic polymer, the acrylic polymer is typically present in an amount from about 30 to about 50 wt. %, with an amount from about 32 to about 48 wt. % being more typical for acrylic polymers. When thermoplastic rubbers are employed as the polymeric binder, the thermoplastic rubber is typically present in an amount from about 8 to about 18 wt. %, with an amount from about 10 to about 15 wt. % being more typical. The amounts of the various components specified herein are based on 100% of the total mixture.

The coating composition of the present invention also includes a polymeric carrier. The type of polymeric carrier employed in the present invention is dependent on the type of polymeric binder used. For thermoplastic polymers, the polymeric carrier is typically water. When thermoplastic rubbers are employed as the polymeric binder, the polymeric carrier is a hydrocarbon solvent such as napthanol, mineral spirits, ketones, napthas and the like. The polymeric carrier is present in the inventive coating composition in an amount from about 2 to about 40 wt. %, with an amount from about 6 to about 25 wt. % being more typical for thermoplastic polymers and rubbers.

The intumescent agents employed in the present invention impart fire-resistance characteristics to the resultant coating. Illustrative examples of intumescent agents that can be employed in the inventive coating composition of the present invention, include, but are not limited to: heat expandable graphite particles A mixture of the aforementioned intumescent agent with another known intumescent agents is also contemplated in the present invention.

In a preferred embodiment of the present invention, the intumescent agent is heat expandable graphite. Heat expandable graphite is formed by treating crystalline graphite, which is composed of stacks of parallel planes of carbon atoms, with intercalants such as sulfuric acid and/or nitric acid. Since no covalent bonding exists between the planes of the carbon atoms, the intercalant can be inserted therebetween. This allows the intercalant to be positioned within the graphite lattice. When the intercalated graphite is exposed to heat or flame, the inserted molecules decompose and release gases. The graphite layer planes are forced apart by the gas and the graphite expands, thereby creating a low-density, non-burnable, thermal insulation that can reflect a high percentage of heat.

The heat expandable graphite particles as well as other intumescent agents used in the present invention exhibit effective flame retardant properties and significantly reduce the smoke density and the self-extinguishing time of the polymeric binders without adversely effecting the physical properties of the coating compositions. The preferred heat expandable graphite particles have “onset” temperatures from about 160° C. to about 230° C. The particles undergo dramatic expansion upon exposure to heat and flame. More particularly, the volume of the preferred graphite particles can increase to greater than 80 times their original volume in just a few seconds.

An example of expandable graphite particles that can be used in the present invention is GraftGuard™ Grade 220-80N. In some embodiments, the neutral graphite (designated by N) can be replaced with a basic graphite. This intumescent material is a graphite flake that begins to show significant expansion from 180° to 230° C. Because of its high on-set temperature, the preferred expandable graphite material can be used in applications where processing temperatures may reach 210° C. The particle size of the preferred expandable graphite particles employed in the present invention is from about 130 to about 320 microns.

The intumescent agents are typically present in the resultant mixture in an amount from about 0.5 to about 35 wt. %, with an amount from about 1 to about 10 wt. % being more typical, and with an amount from about 4 to about 8 wt. % being even more typical. The amount of intumescent agents is based on the total solids content of the inventive mixture. When heat expandable graphite particles are employed, a preferred range is from 1 to about 10 wt. %.

The other component of the inventive coating composition is a pigment. The pigment employed in the present invention can be any pigment that is capable of providing a highly reflective coating after the resultant mixture is cured. Typically, the pigment provides a coating that is white in color. Various shades of white are also possible as well as other colors that are capable of providing a coating that is highly reflective.

Suitable pigments that can be employed in the present invention include, but are not limited to: titanium dioxide, calcium carbonate, colemanite, aluminum trihydride (ATH), borate compounds, and mixtures thereof. One highly preferred pigment employed in the present coating composition is titanium dioxide, which is also considered to be a UV blocker.

The pigments are employed in an amount that is efficient for providing a coating composition that has an initial energy efficiency rating greater than or equal to 0.65 for a low-sloped roof, or an initial energy efficiency greater than or equal to 0.25 for a steep-sloped roof. The reflectivity provided by the inventive coating composition, which is dependent on the degree of sloping of the roofing product, meets today's Energy Star® standards.

The pigments are typically present in the resultant mixture in an amount from about 2 to about 20 wt. %, with an amount from about 5 to about 15 wt. % being more typical for one of the aforementioned pigments. Note that fillers have a higher concentration than do the pigments used in the present invention.

The energy efficiency of the coating is determined by measuring its initial solar reflectance using ASTM E 903 (Standard test method for solar absorptance, reflectance, and transmission of materials using integrating spheres). Alternatively, the initial solar reflectance can be determined by ASTM C 1549 (Standard test method for determination of solar reflectance near ambient temperature using a portable reflectometer).

In addition to having the aforementioned initial solar reflectance values, the coating of the present invention needs to be capable of maintaining a solar reflectance for three years after installation on a low-sloped roof under normal conditions of greater than or equal to 0.50 (measured from the first year after installation). For steep-sloped roofing products, the coating of the present invention has to maintain a solar reflectance for three years after installation under normal conditions of greater than or equal to 0.15 (measured from the first year after installation).

Maintenance of solar reflectance of a roofing product can be determined using the current guidelines mentioned in the Energy Star® program requirements manual. The test can be carried out using ASTM E 1918 or ASTM C 1549 for low-sloped roofing products. ASTM C 1549 can be used in the case of steep-sloped roofing.

The coating composition of the present invention, which comprises a mixture of at least the above-mentioned components, may also include other optional components that are typically employed in coating compositions. For example, the coating composition of the present invention can include any of the following components:
dispersants such as potassium triphosphosphate, acrylic polymers or copolymers, and the like;
defoamers that are capable of preventing foaming;
fillers such as calcium carbonate, talc, white sand and the like;
solvents that are capable of serving as a coalescing agent such as ethylene glycol, propylene glycol, alcohols, and the like;
microbiocides that serve as fungicides, e.g., zinc oxide;
thickening agents such as hydroxethyl cellulose, polyurethane, and the like;
additional fire retardants such as alumina trihydrate, zinc borate, alkali metal silicates, and the like;
pH modifiers such as aqueous ammonia;
wetting agents such as siloxanes;
light stabilizers such as hindered amines; and/or
adhesion promoters such as hydrocarbon resins.

The optional components mentioned above are present in the coating composition of the present invention in amounts that are well known to those skilled in the art. The optional components are typically present in the mixture prior to the addition of the intumescent agent.

The coating composition of the present invention is prepared by first providing a mixture of at least the polymeric binder, the polymeric carrier, the pigment and the other optional ingredients and then adding the intumescent agent, preferably expandable graphite particles, thereto while maintaining constant mixing. The addition of the intumescent agent typically occurs at nominal room temperature (20° C.-40° C.). Alternatively, the addition can occur at temperatures above nominal room temperature provided that the addition temperature does not exceed the on-set temperature of any intumescent agent that is being used, e.g., expandable graphite particles. Mixing occurs using any mixing apparatus that can operate under low sheer conditions. By “low sheer” it is meant a mixing speed of about 60 rpm or less, which speed is capable of providing and maintaining a homogeneous mixture.

The mixing provides a blend (or emulsion) of components that can be applied immediately to a surface of a building materials product or the resultant mixture can be stored for several weeks or month prior to application.

The resultant coating composition of the present invention can be applied to any substrate or material layer thereof, especially roofing products or other related building materials products, by brushing, roller coating, spray coating, dip coating, squeegee and other like coating procedures. After applying the coating composition of the present invention to a surface of a substrate or a material layer, the coating composition is cured at the temperature of the environment in which the coated substrate or coated material layer is located. Curing can take place in just a few minutes or longer depending on the thickness of the applied coating as well as the environmental temperature.

The coating composition of the present invention is generally, but not always, applied to the exterior surface of a substrate or material layer, i.e., on the outermost layer of the building materials product. In particular, the coating composition is generally applied to an expose exterior surface of a roofing product including low-sloped roofing products such as single ply membranes, built-up roofing (BUR), modified bitumen, ethylene propylene diene monomer (EPDM) rubber and standing-seam profile metal roofing, or steep sloped roofing products such as composite shingles, clay, concentrate, fiber cement tile, slate, shakes, architectural profiled metal and individual roofing components. In some preferred applications, the coating composition of the present invention is applied to BUR surfaces, modified bitumen and EPDM rubber.

After application and curing, a coating is provided to the substrate or material layer that provides durable protection to the substrate or layer from abrasion, impact, water, and other environmental factors. Moreover, the coating provided by the present invention is capable of extending the lifetime of the current roofing system. The coating provided in the present invention is also breathable meaning that it has excellent porosity, which allows for venting of vapors. Another characteristic of the coating formed from the coating composition is that the resultant coating has superior fire retardant capabilities. When introduced to flame (fire), it has the ability to char, allowing the intumescening agent, namely graphite to expand, encompass the flame and further retard and prevent it from progressing further. Hence, the intumescent agent, such as expanded graphite, provides flame retardation by limiting the amount of oxygen present to the fire.

In addition to the foregoing properties, the coating that is formed using the inventive composition has a high reflectivity that meets and even may exceed current Energy Star® values.

The following tables illustrate four exemplary coating compositions of the present invention which provide durable exterior protection to a surface in which they are applied. The exemplary coating compositions of the present invention also exhibit superior fire-resistance and are highly reflective meeting today's Energy Star® criteria. Coating Compositions A-D are made by first providing an emulsion that includes each of the named ingredients minus the GrafGuard® 220-80N (expandable graphite flakes which are used as the intumescent agent in the following examples). The GrafGuard® 220-80N is then added as described above and the admixture is stirred to provide a coating composition of the present invention. Coating compositions A, B and D include an aqueous acrylic-based emulsion and GrafGuard® 220-80N, while coating composition B includes a solvent-thermoplastic rubber-based emulsion and GrafGuard® 220-80N.

TABLE 1
Coating Composition A

| Component/used as | % Range |
|---|---|
| Water/polymeric carrier | 23.5-28.8 |
| Potassium | 0.12-0.14 |
| tripolyphosphate/dispersant | |
| Acrylic polymer/dispersant | 0.15-0.19 |
| Defoamer/foam protection | 0.34-0.42 |
| Acrylic emulsion/binder | 30.3-37.1 |
| Calcium Carbonate/pigment | 20.5-25.1 |
| Titanium dioxide/pigment | 9.3-11.4 |
| Alcoholic solvent/coalescing | 0.6-0.74 |
| agent | |
| Microbiocide/fungicide | 0.14-0.17 |
| Ethylene Glycol/coalescing | 1.4-1.7 |
| agent | |
| Hydroxyethyl | 0.28-0.34 |
| cellulose/thickener | |
| Graphite flake/fire retardant | 3.2-4.0 |

TABLE 2
Coating Composition B

| Component/used as | % |
|---|---|
| water/polymeric carrier | 9.1-11.1 |
| Potassium | 0.21-0.25 |
| tripolyphosphate/dispersant | |
| Acrylic polymer/dispersant | 0.21-0.25 |
| Defoamer/foam protection | 0.4-0.5 |
| Thickener/additive | 0.17-0.21 |
| Acrylic emulsion/binder | 41.4-50.6 |
| Titanium dioxide/pigment | 5.0-6.0 |
| Aluminum trihydrate/fire | 25.0-30.6 |
| retardant | |
| Zinc borate/fire retardant | 2.1-2.5 |
| Zinc oxide/fungicide | 0.41-0.50 |
| Aqueous ammonia/pH | 0.12-0.14 |
| modifier | |
| Polydimethyl | 0.17-0.21 |
| siloxane/wetting agent | |
| Alcoholic | 1.65-2.01 |
| solvent/coalescing agent | |
| Polyurethane/thickener | 0.36-0.44 |
| Microbiocide/fungicide | 0.23-0.29 |
| Graphite flake/fire retardant | 3.93-4.81 |

TABLE 3
Coating Composition C

| Component/used as | % |
|---|---|
| Napthol/polymeric | 7.5-9.1 |
| carrier | |
| Naptha/polymeric | 22.4-25.0 |
| carrier | |
| Hindered amine/light | 0.66-0.8 |
| stabilizer | |
| Defoamer/prevents | 0.66-0.8 |
| foaming | |
| Copolymer/dispersant | 1.7-2.1 |
| Titanium | 11.5-14.0 |
| dioxide/pigment | |
| Aluminum | 21.9-26.8 |
| trihydrate/fire | |
| retardant | |
| Hydrocarbon resin/ | 3.0-3.7 |
| adhesion promoter | |
| Hydrocarbon resin/ | 7.0-8.5 |
| adhesion promoter | |
| Thermoplastic rubber | 10.0-12.2 |
| (SEBS)/polymeric | |
| binder | |
| Graphite flake/fire | 3.9-4.7 |
| retardant | |

TABLE 4
Coating Composition D

| Description/used as | % |
|---|---|
| Water/polymeric carrier | 10.8-13.2 |
| Potassium | 0.1-0.12 |
| tripolyphosphate/dispersant | |
| Acrylic polymer/dispersant | 0.34-0.42 |
| Defoamer/foam protection | 0.27-0.33 |
| Acrylic emulsion/binder | 29.8-36.4 |
| Calcium Carbonate/pigment | 30.0-36.6 |
| Titanium dioxide/pigment | 5.0-6.1 |
| Zinc Oxide/fungicide | 3.33-4.07 |
| Alcoholic solvent/coalescing | 0.5-0.61 |
| agent | |
| Microbiocide/fungicide | 0.15-0.19 |
| Aqueous ammonia/pH | 0.07-0.09 |
| modifier | |
| Propylene glycol/coalescing | 1.73-2.11 |
| agent | |
| Hydroxyethyl | 0.3-0.36 |
| cellulose/thickener | |
| Graphite flake/fire retardant | 4.02-4.92 |

TABLE 4
UL Burn Data

| | | |
|---|---|---|
| Class A: 2″:12″ | Deck-4″ ISO, | TEST 3: w/batten |
| | EverGuard EPDM | bar, membrane |
| | FR MA, Surface | caught at 41 secs, |
| | Seal SB FR | total burn 4 |
| | (1.5 g/sq-1742 grams) | ½′ . . . Passed 1 |
| | | ½″:12″ Class |
| | | A . . . grandfathered |
| | | 2″:12″ Class A. |

The above data is from UL (underwriters labs) test results on an intumescent coating of the present invention. The data shows that the coating provided enough fire resistance to obtain a class A rating on an EPDM substrate. Current reflectivity on this coating is 73%.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

1. A coating composition comprising:
a mixture of a polymeric binder, at least one intumescent agent, a polymeric carrier and an effective amount of a pigment that is capable of providing a coating that has an initial energy efficiency rating greater than or equal to 0.65 for a low-sloped roof, or an initial energy efficiency greater than or equal to 0.25 for a steep-sloped roof, wherein said mixture has a solids content from about 30-80% of which 0.5-35 wt. % is said at least one intumescent agent.

2. The coating composition of claim 1 wherein the polymeric binder is a thermoplastic polymer or a thermoplastic rubber.

3. The coating composition of claim 2 wherein the polymeric binder is a thermoplastic polymer selected from the group consisting of acrylic or methacrylic polymers or copolymers, epoxy resins, polyvinyl acetate, and urethane.

4. The coating composition of claim 2 wherein the polymeric binder is a thermoplastic rubber selected from the group consisting of styrene-butadiene rubbers, styrene-butadiene-styrene rubbers, styrene-ethylene-butadiene-styrene (SEBS) rubbers, styrene isoprene styrene (SIS) rubbers, and styrene butadiene rubbers.

5. The coating composition of claim 1 wherein the polymeric carrier is water or a hydrocarbon solvent.

6. The coating composition of claim 1 wherein the pigment comprises titanium dioxide, calcium carbonate, colemanite, aluminum trihydrate (ATH), borate compounds or mixtures thereof.

7. The coating composition of claim 1 wherein the pigment is titanium dioxide.

8. The coating composition of claim 1 wherein the polymeric binder and the polymeric carrier form an aqueous polymeric-based emulsion.

9. The coating composition of claim 1 wherein the polymeric binder and the polymeric carrier form a solvent polymeric-based emulsion.

10. The coating composition of claim 1 wherein the polymeric binder is present in said mixture in an amount from about 5 to about 60 wt. %.

11. The coating composition of claim 1 wherein the polymeric carrier is an acrylic polymer that is present in said mixture in an amount from about 30 to about 50 wt.

12. The coating composition of claim 1 wherein the polymeric carrier is a thermoplastic rubber that is present in said mixture in an amount from about 8 to about 18 wt. %.

13. The coating composition of claim 1 wherein the pigment is present in said mixture in an amount from about 2 to about 20 wt. %.

14. The coating composition of claim 1 wherein said at least one intumescent agent comprises expandable graphite particles.

15. The coating composition of claim 1 further comprising one or more optional components selected from the group consisting of dispersants, defoamers, fillers, solvents, microbiocides, thickening agents, additional fire retardants, pH modifiers, wetting agents, light stabilizers, and adhesion promoters.

16. A coating comprising:
a cured reaction product of a polymeric binder, at least one intumescent agent, a polymeric carrier and a pigment, said cured reaction product having an initial energy efficiency rating greater than or equal to 0.65 when applied to low-sloped roof, or an initial energy efficiency greater than or equal to 0.25 when applied to a steep-sloped roof.

17. The coating of claim 16 wherein said at least one intumescent agent is expandable graphite particles.

18. A roofing product comprising the coating of claim 16 and at least one of a substrate or a material layer of a building materials product.

19. The roofing product of claim 18 wherein the substrate has surfaces with a slope of 2:12 inches or less.

20. The roofing product of claim 18 wherein the substrate has surfaces with a slope of greater than 2:12 inches.

21. The roofing product of claim 18 wherein the substrate comprises composite shingles, clay, concentrate, fiber cement tile, slate, shakes, architectural profiled metal or individual roofing components.
